(19) United States
(12) Patent Application Publication
(10) Pub. No.: US 2012/0030474 A1
(43) Pub. Date: Feb. 2, 2012

(54) System and Method for Personal Biometric Data Sequestering and Remote Retrieval with Power Checking

(75) Inventor: Douglas Allen Sayler, Omaha, NE (US)

(73) Assignee: Douglas Sayler, Council Bluffs, IA (US)

(21) Appl. No.: 12/698,950

(22) Filed: Jul. 28, 2010

(51) Int. Cl. G06F 21/00

(52) U.S. Cl. 713/186

(57) ABSTRACT

Provided is a sequestered personal match server apparatus and protocol for remote use, across common telecommunications technology or infrastructure, for establishing a blinded, zero-knowledge transaction between distributed computing devices, in which personal data is stored or retrieved and may be further transmitted or represented to the user's selected transaction counterparts, including boundary-keepers. A user may cloak their legal identification in some transaction or may substantiate it, since the capacity of proving the user's traceability to their legal identity is consistent with an electronic report issued to any user-queried interests indicating the success or failure of an attempt at accessing the data within the device. Biometrics and device sequestration are viewed as synergistic enhancements to scalability, including methods of power-checking any attempt at breach by or through various agencies of a commercial, private or public market. Transparency of use is further emphasized by relying upon common, mature electronics, which the user may bootstrap and use, unaided. The more important embodiments assume a role for a public witness agent or officer, during commissioning or first-use of said electronic device. A preferred embodiment further develops wireless networking synergies in approaching personal safety as an economic concern.

### BACKGROUND OF THE INVENTION

1. Field of the Invention

The present invention relates to the use of personal computing devices in a manner related to so-called “smart cards” for commerce or security access, through a distributed transaction system. This field is involved with digital signatures and protocols for their transmission, including blind transfer encryption methods. This disclosure views biometric scanning technology as a preferred means of providing convenience in the above matters. The field relates to computer matching devices in a networked environment. A so-called synchronization server computer may be used.

2. Description of Related Art

The following may be elucidative toward the present invention, without being prior art per se:

| App/Patent #s | Title |
|---|---|
| 6,985,839 | System and Method for Wireless Location Coverage and |
| | Prediction |
| 7,142,873 | System and Method for Calibration of a Wireless |
| | Network |
| 10/339,937 | System and Method for Managing Transportation Assets |
| 5,903,880 | Self-Contained Payment System with Circulating Digital |
| | Vouchers |
| 7,089,208 | System and Method for Electronically Exchanging Value |
| | Among Distributed Users |
| 20090183247 | System and Method for Biometric Based Network |
| | Security |
| 6,850,147 | Personal Biometric Key |

The inspiration for the present invention springs from the predecessor to this disclosure U.S. Provisional Patent 60/883033 “Continuous locating apparatus . . . with [RF] transponder, Interpolation and DSRC,” wherein economic stability and personal safety is viewed as a single concern. The preferred embodiment therein imagines a national road transportation infrastructure as transformed into an integrated system. The most physically distinct bridge between the retail/commercial applications of the present invention, and the more extended concerns of free association and human security is the “Data Vault” of 60/883033, which is the “Data Safe” of the present invention. The “Wi-Fi” telecommunications system described as “Multiband Configurable Networking Unit,” MCNU, in the Technocom, Inc. Patent (U.S. Pat. No. 7,142,873) is assumed to be exemplary technology related to methods described in the preferred embodiment of both inventions mentioned above.

While other inventions generally address the use of personal biometric sensors, and other inventions address the use of a portable RF device for transmitting a private code, the present invention is a unique adjunct to networked value transactions in that emergent difficulties may be resolved in-process by empowering users with simultaneous tracking by impartial legal or erstwhile public means. All previous art renders a user further subservient to economic and political authorities, by several measures. Use of the present invention is intended to diminish the investigative and executive roles of public and private authorities in the course of settling value transactions, an intent made manifold in the context of the preferred embodiment. An economy that prefers more legalistic or contractual means of business instead of post-hoc authoritarian measures also enjoys less political hubris and its participants should feel more empowered. Such is an indication that economic endeavors of the participants are indeed more efficient, rather than some multitude of curios and amusements. The first indication is that of a reduction in basic costs of living; the other indication is that of increasing demands for participants to produce for their economy. The latter owes its nature to a lack of respect for human dignity, which is easier understood in terms of preferred embodiments.

In fact, much work in transaction authentication has followed the popularization of the internet, and these methods commonly display adequate planning as to front-side issues, such as properly identifying the initial querying agent or potential buyer. Such an initial correspondent is always called upon to work on behalf of the party to whom they are inquiring for their various business concerns, each and every time they do transact.

This work generally amounts to programming a personal identifier database with arbitrary facts of the user's personal background or choosing, and also managing these many facts with their own resources. The querying agent is required to perform these repetitive functions for every point of interest from which they may seek deeper information about some product, including ownership, so that much or even all of their private facts are transferred to the commercial arena. Also, since the queried agent or potential seller may be properly considered the party with the product, and hence more highly capitalized than the initial agent, the personal facts entrusted to them are worth far less to themselves than to those to whom the facts belong, but who no longer own them. Prior art in this field indeed consists of marvelous works of logic, all of which is predicated on an appeal to elite authorities as the final word on transaction authenticity—with the supply-side holding primacy in relation to that authority. By thusly subverting attempts at public purview over transaction disputes, one party gives up a rightfully equal status, in trade for a margin of security for their personal facts. Mathematically, one's credit card use may contrast the qualities of useful (aka “zero-knowledge) authentication methods. Common systems are computationally weak, so that a card number may be produced from brute-force efforts, given fragments of the usual 16-digit series, as gleaned from servers or bank computers which have been compromised. Statistically, it may only be a matter of time before one's credit card is stolen, by deception or by force, thus reducing their financial records to a means of undoing their lives, generally. Ultimately, current schemes are authoritarian hierarchies of trust, which use the destruction of the user to compensate for any compromise of the system itself.

Quasi-authoritative approaches to personal verification do include existing match-server systems. In the end, these schemes all depend on how authorities entrusted with their respective security trusts view the willingness of their insurors to cover internal or external breaches. The moral hazard therein is magnified by the capital-intensification that lends the regime described above to even the most genuine such authority. No matter how commercially successful such an authority may become, the generalized incentive for misdeeds is ever-present. Any breach of some would-be bulwark of an economy, causing personal injuries to some individual, must result in compensation by those supposedly responsible authorities. That some presumed economic underpinning might be freed from a security trust it has pledged to the public by courts or by manufactured public consent, such as to promote an appearance of strength, is suggestive of a back end-weighted economy. Such institutions may be subordinate only to publicly elected officials, and this describes an economy that tends to define itself in terms of economic externalities, one in which the efforts of individual participants mean little. This is propagated by an increasing basic cost of living endemic to this paradigm.

Biometric security refers to using “something you have” as an authentication factor. Some common biometrics are fingerprint, facial, voice, retinal, and hand geometry. Biometric security requires more specialized hardware and software than labor-intensive methods, such as photographic and mnemonic, due to the nature of the data captured by this factor. The major failing of traditional “honor system” methods is that their dependence upon vertical economic systems means that in submitting data for authentication, the data itself is placed in jeopardy at the outset of a transaction. Motivation does exist for authorities vested with the conflicting roles of gatekeeper and protector of those submitting facts of authentication, to emphasize capital assets over human welfare.

The present invention makes use of wireless digital networking, as well. All prior art assumes a user to apply a password to a networked environment in much the same way as one would use a kiosk, such as ATM. However, this guarantees that anyone with knowledge of wireless transmission protocols and a moderate budget for eavesdropping technology can obtain a message, be it encrypted or not, from users frequenting a given communications reception location or system. Institutional resources for encrypting wireless transmissions are regularly defeated, thus forcing industry to devise heftier encryption protocols, which forces users to adopt password means of greater complexity and cost, which forces infrastructure concerns to upgrade their computing bandwidth capabilities. This is a development plan designed to fail, and ultimately leaves little hope of being a permanent part of civil society. U.S. Pat. No. 6,850,147 “Personal Biometric Key,” and also the Detailed Description herein, mentions an apt direction this issue can turn. Not only does a traditional “cat and mouse” regime ultimately reduce to a command-controlled economy, all identity authentication schemes suffer from a curious duality: in a broad consumer marketplace, adoption is subservient to a populist appeal toward looser control. Either tight controls alienate and distort the marketplace, or accuracy suffers badly from a well-paying but marginalizing consumer public, and the appeal for refuge under a central authority then reappears.

The deterministic outlook for porting this cat-and-mouse approach to semiconductor means, as in the aforementioned development plan is that a breakdown of Moore's Law will eventually deliver the fastest consumer computing machines straight into the hands of the common identity thief. So the conventional solution would seem to lie in increasing bandwidth, and requiring ever-larger biometric datasets. Eventually, such an enterprise might become so consolidated and well-capitalized as to permit the hashing and transmission of whole characterizations of one's genome to an institutional authority, as a personal password.

This disclosure finds that all prior art approaches matters of personal safety from criminal assault as an issue best launched into as an aristocratic toy. Marketplaces which appeal to the graces of institutional goodwill provide chinks in the armor for marginalizers to attack, whether from within an institution, or by outside speculators. There is an obvious appeal contained within the present invention, of a certain amount of remedy to a disenfranchising financial industry. A meaningful parallel appeal is modeled in the preferred embodiment, as follows in its own Detailed Description.

Whatever the precise merits, features and advantages of references cited above, none of them fulfills the needs addressed by the present invention.

### SUMMARY OF THE INVENTION

Digital communication networks that employ value transactions between applications are critically tasked with managing the security of the transactions that flow over the network. The present invention combines a means of user authentication and transaction documentation with solid-state electronic construction, the basic operation of which is similar to a light switch, with little of no opportunity for corruption among the elements of said transaction. It is a particular object of the present invention to avoid “appeals to authority” as built-in to the end-state of the method of transacting business. Actual and post-hoc settlements incurred by the novel methods described herein automatically revert to the initial blinded messages of the secure transactions of the present invention. Prior art is viewed herein as appealing to government-chartered legal authorities whose legitimacy is a function of the magnitude of currency they are able to process through an economy.

It is an object of the present invention to enable a sort of “digital handshake” which is more legitimate than anything currently in existence, yet which may be more convenient than even a physical handshake. By such means, including but not limited to public or peer-review, it is intended for the innovations within this disclosure to reduce external supports for value transactions.

A primary object of the invention is to protect against identity theft of the personal biometric data.

An object of the invention is also to provide for authorization decisions to be made not by the biometric sensing device but by a biometric lock connected by electronic means to the portal being accessed, sharing “zero” responsibility to each other, but to the users themselves.

It is also an object of the invention to provide a system for biometric authentications with allowance for customization regarding varying levels of security needs, acceptable risk levels and tolerance or ability for dealing with such technologies.

A further object of the invention is to extend biometric security to wireless and portable devices, and to generally improve the usefulness of existing biometric authentication technology.

A further object of the invention is to provide a system for biometric authentications usable at different locations, with each instance requiring only the same initial training.

It is an object of the present invention to provide a system for biometric authentications which prove reliable for all users.

Another object of the invention is to avoid degradation of biometric sensors due to human and natural environmental factors.

An object is to promote ubiquitous wireless networking infrastructure

An object of the present invention is to encourage better secure servers for electronic networked value transactions, more secure servers in general, as a means of improving the aforementioned transactions, and especially those conducted with some reliance upon wireless electronic networking.

Another object is to promote the growth of dedicated networking lines to provide partial coverage by such lines for the embodiments herein.

### BRIEF DESCRIPTION OF THE DRAWINGS

FIG. 1 is a diagram of a Data-Safe for secure storage/retrieval of personal information. RD[100]-[149]

FIG. 2 is a diagram of the System Authentication/Logon and Route-issuance method of employment of a Data-Safe within the Preferred Embodiment. RD[200] to [249]

FIG. 3 is a diagram of a general Biometric Authentication procedure for electronic transactions.

### DETAILED DESCRIPTION OF THE INVENTION

The description uses the terms match server and Data Safe (or Data Vault) interchangeably.

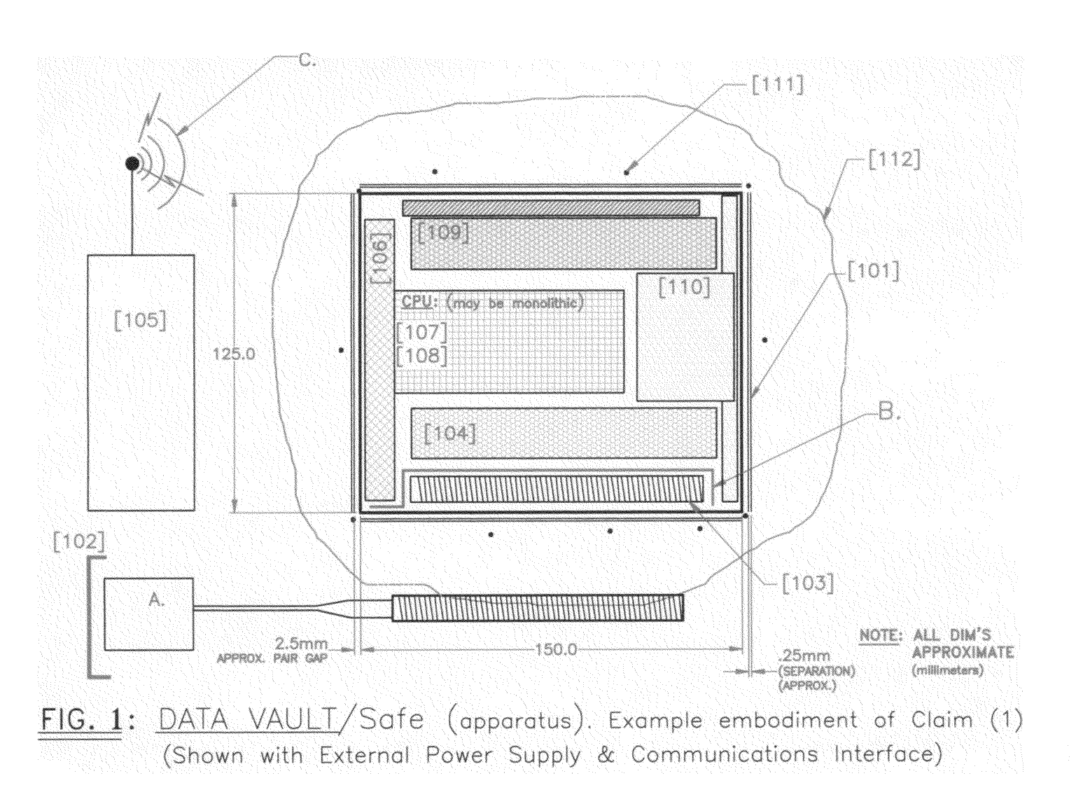

The basic design of the invention allows for several important modifications or additions, but the main theme is private ownership. The solution to problems as recently mentioned in Prior Art must focus on keeping the user's biometrics utterly sacrosanct. FIG. 1 shows a device, for personal data management, which relies upon some authority which the owner and any agent of the owner's choosing both consider ideal for witnessing a proper operation of the device. The device is hermitically sealed and intended to be inviolable, the vital components of which are durable for a lifetime of proper functioning. The device is built upon a simple structural frame [100] and may be enclosed by a metal foil shield [101] which alarms the device when probed. The device requires a simple inductive charging unit [102/103], and durable energy storage such as supercapacitor (ultracapacitor) and a power management system [104] which recognizes any prolonged loss of power as an attempt at breach. One or more Write-Once, Read-Many memory devices [108] are used to store biometrics and to enable transfer-of-ownership. Data transmission protocol is handled by a simplified OS stored in firmware within microprocessor [107] or RAM mass data storage [109] and is effected by RF transceiver set [105/106]. The device is encased in a solid mass of epoxy for physical protection, which includes sensors [111] for detecting externally-induced ablative or frictional heat, and also fibers which emit signals when broken, such as piezoelectric quartz or other means useful to the computational facilities of the device. Proper access of the device may be used as proof-of-identity, and may initiate transfer of stored or submitted information according to user commands.

In all embodiments to the present invention, fingerprint scanning digitizers are assumed to be the standard means of biometry, although the present invention records any digital representations equally well. The digital scanning devices (7) currently popular incorporate a Charge-Coupled Device (CCD) array and a light source. Many biometric measures may be used within the present invention; even one's unique DNA has a graphical nature to its chemical structure, which can be plotted on a graphical coordinate scale, and which is useable herein.

Any personal security solution that is very user-accessible will encourage voluntary rotation of user settings—a truly random element—and in the present invention, this includes which exact biometrics feature sets to use, the number of failed access tries to allow, and the exact notifications (such as to user mobile phone, or even EPIRB) and actions to perform under such an apparent attack, such as time-dependent or further-notice lockout, or data obliteration. Indeed, as revealed in (1) (2) and (11), multiple graduated means of sequestering the Data Safe protect against unauthorized physical contact, or any unauthorized probing of any sort, with user-selected alarms and graduated self-destruction, provide comprehensive security from legal or extralegal attempts at forceful access.

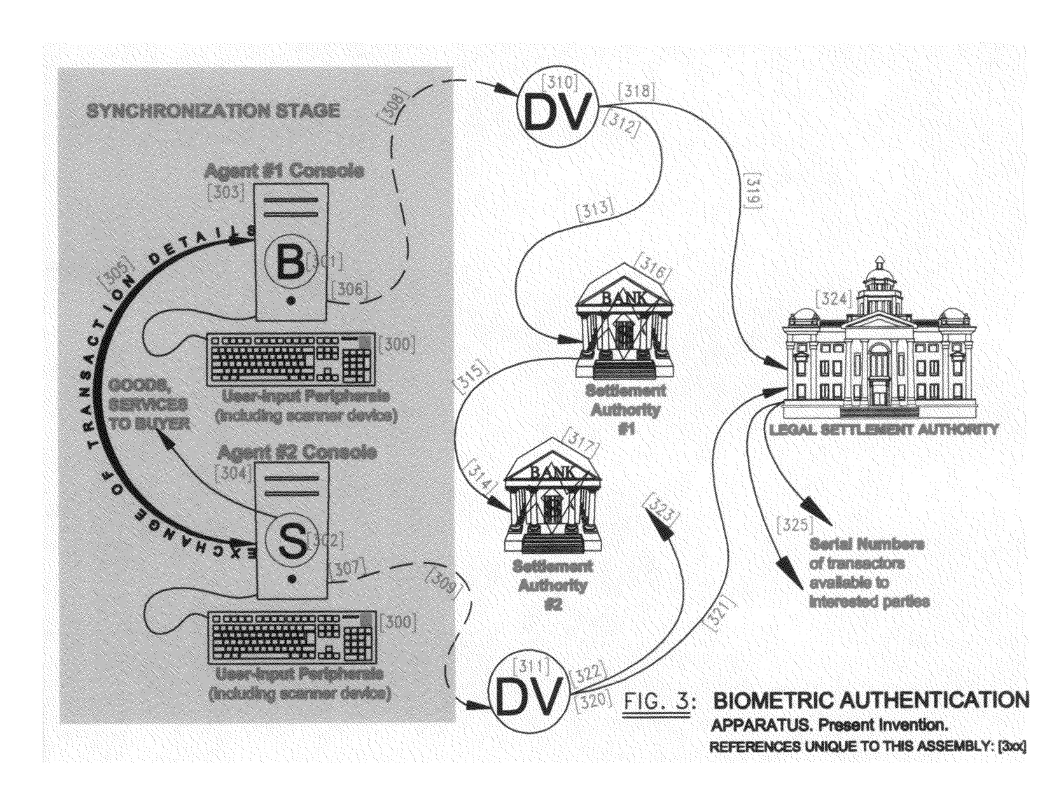

One embodiment for making value transactions is shown in FIG. 3. The process begins with two transacting agents 301/302, who exchange verbal instructions 305 describing the terms of the transaction to be satisfied by both. Each agent uses a computer console 303/304 containing automated client software to encrypt their copy with their own biometric numerical seed value, which hashes the message according to computer instructions mutually agreed to by a user's local and remote devices. The message necessarily includes a network address of the destination to which the transaction must proceed for the value to be registered in the name of the other party. The message sent by the agent receiving settlement from said settlement authority 309, is itself is a receipt only of value to the system, while being sent through the system. When the messages arrive at the address of their respective owner's data safes 310/311, they are recognized by the serial number they assumed from the owner's digitizer device 300. Each message is decrypted and the enclosed address of the settlement authority of each user's choosing is added to the aforementioned header of the message, or the seed value is entirely stripped from the message, which may need no further encryption if the settlement authority has a dedicated network connection to said hosting authority of data safe devices. A client-side inclusion in every transmission header of a unique mathematical indicator of any encrypted biometric dataset may be useful within the present invention for comparison to an internal index of all of the user's possible biometric combinations, for friend-or-foe deterrence. An executive function within the hosting authority may provide further deterrent.

A synchronization step is important between the console stage and the data safe hosting authority, inclusive, so that the datasafes can send a copy to a settlement authority of last resort, namely a secure server 324. This is a black box to the world, with the exception of some individual who would inquire of an exact serial number appearing within a list of time stamps spanning a time not to exceed a standard allowance for any message to pass through a data vault processing center. By this means, the transacting agents' serial number will be obtainable to each other, and by public courts or court officers, or other agent vetted to verify the mutuality of the agreement details. FIG. 1 shows the important components of the Data Safe, with those implicit to this embodiment being the wireless communications transceivers [105/106]. These may be microwave-frequency to balance bandwidth and penetration through RF-obscuring fibers or piezoelectric fibers and foil pairs.

If this embodiment were to make use of wireless communications, a console could be a wireless transmitting device, in the form of a so-called smart phone. In such an embodiment, the preceding method is accurate, but the initial link would require a top-layer of encryption provided by a hosting authority of one's data safe device. Wireless communications with one's device, as held residentially or in an office setting, would rely entirely upon security provided by one's telephony service. The preferred embodiment is described below as supporting this utility from an automobile. Continuing, the hosting authority encryption protocol could label a transmission as being of wireless origin before it enters its Data Safe, which then generates a random password automatically for a given transaction, sending it as a receipt to the owner for use at a later time. This is a Zero-Knowledge application, where proof of authenticity is made without providing any useable password data. Mobile telephony users not relying on the separate security service of the present invention may have a very complicated password stored on their phone, betting that the phone will not be stolen. Otherwise, a general improvement for wireless electronic value transactions might be for well-capitalized institutions to provide so-called “hard points” to which users would restrict their communications of this sort, so that a security guard or some automated means would monitor and check suspicious use of general purpose portable computing devices, such as notebook computers. This assumes that software to perform this kind of eavesdropping activity would be legally barred from being used on handheld computing devices.

In the above description of FIG. 3, the first connection 306/307 uses a blind transfer to maintain anonymity for the sender. Since the transmission is named as a serial number of the digitizer that produced the encryption seed value, and the data safe is generic and held en masse, and furthermore uses automated means to filter out all transmissions to the address of the so-called co-location center except those properly formed, presented and named per that serial number, the transmission is “zero-knowledge,” per (11) which is defined by serial-number anonymization as in (12) or (16). Network protocols have their own security features, such as parsing data into packets and dispersing them to entirely separate communications nodes along their journey to their ultimate destination and reconstitution into their original form—making theft of these messages while en route an extravagance. This mitigates the expected value of unauthorized recovery operations.

The transmission link above is anonymous, may benefit from hashed data-packet transmissions, and the body of the message is deeply encrypted. Fingerprints, for example, typically have at least four easily identifiable telltales, each. If a user chooses four fingers of a possible ten, and may repeat a print in a so-called characterization multiple times according to presets within the data safe software or firmware, and if a scanner is divided into 200 or more logical sectors with which to locate any given telltale, then the number of permutations therein will yield a seed for large key-size encryption; unbreakable by any semiconductor, so-called microtechnology means commonly available. The objective herein is to reduce the expected value of breaches of such transmissions to a practical zero, far into the future, and similarly the chances of unauthorized use of the personal match server.

The “downlink” connection to the settlement authority 312/322 is a dedicated wire line or secure connection, such as Virtual Private Network, which effectively makes that transmission inviolable. Connection 322 is primarily a trigger for 321, similar to 319, and may be over common Internet. The transmission header is needed for potential future interface with the last resort authority, while the copy itself may be destroyed according to published agreement with the user. The secure connection leading to the settlement authority of last resort (324) is similar as 312/322. This feature of the invention is important for three reasons: first, the robustness of the authentication makes it seem a worthy steward of the public trust; second, all value transactions involving currency are legal agreements which may or may not be binding; finally, not only is this a convenient function for such a robust security system as the present invention—it seems to be a similarly convenient service for the public courts to draw upon. In fact, some kinds of common fraud would be unthinkable with the availability of the present invention, and many other disputes may be aided by the encouragement this user-oriented system provides toward those who prefer Zero-knowledge authentications and the highest legitimacy in their value transactions.

Another embodiment for preventing emergent difficulties in value transactions involving hard goods, delivered through common carrier, would likewise streamline and support end-user freight delivery operations throughout the greater economy. This embodiment makes use of the idea of a transferred Point-Of-Sale, as a means of empowering remote, or virtual, sales operations of all types to benefit from the one remaining advantage of showroom sales operations—namely, physical inspection of an article before a change of ownership. Specifically, freight delivery services could put delivery terminals in a vast many more communities than the current reliance upon megalopolis-based operations, if customers were willing to forego doorstep delivery—always incurring some uncovered risk to both buyer and seller—in favor of inspection at the transferred POS. The freight operation would provide digital filming of the intended buyer's reveal, which would transmit by a secure network connection to the data safe of an employed agent for this purpose—with a copy, automatically sent to the so-called last-resort authority, thus verifying visual and some functional satisfaction as completion of such a transaction. In return, the shipper may opt for standardized and fully reusable packaging materials, perhaps of a modular, durable-goods design, thus greatly reducing shipping expenses, including time, and making fussy and even improbable door-step deliveries a premium service.

Any consumer-driven culture will have substantial needs for authentication of persons and capital assets held by such persons. Also, the less dependent human knowledge is upon the volume of physical trade, the more legitimate this commerce must be and therefore the more it must rely on alternate means to legitimize its relevance than mere physical possession, or authorizations leveraged by superior capitalization. This is as true for intellectual capital such as electronically-obtained music or other entertainment media as it is for one's own decoded genome.

In one such embodiment, the Data Safe device itself stores sensitive personal data items, and dispenses any of these on command to a network address of the user's choosing, using the device in the manner of personal computer mass-storage devices. The data items would be transmitted by secure means described above, or they may be included as the blinded message body so that a key code may be provided by some entirely alternate means.

Another such embodiment would enhance Digital Rights Management (DRM) efforts as applies to media which is not character-based, such as photos and audio or video streams. Every copy of a given work distributed to end-users would be imprinted with a computer-generated watermark or other such code too subtle for human perception. Any such copy or segment thereof remaining on a commonly-available server may then be detected by commonly available computer instructions, or software. When an authorized merchant of such wares transmits such product by networked means, they may instruct intermediating agents such as networked file server operators to securely dispose of any such remnants from their network hardware. Any remnant with a particular watermark is therefore evidence that a copy of that product provided through the unique serial number of a customer's own Data Safe hardware was in fact transmitted in violation of its author's intentions.

In another embodiment related to aforementioned network sales transactions for digital products, any unsuccessful transaction may be performed with the same steps as (14), with the added inclusion of a user-entered synchronization mark per (18), being similar to the marking given said unsuccessful transaction, such that the request for a repeat is passed through the device, including a user requirement for the product to be the actual body of the transaction response. This leaves a copy of the request on a last-resort settlement file server, as is any response to this request. A failed receipt of product is acknowledged or ignored by the supplying agent at their own risk, although digital copies are virtually without cost. Similarly, a defective product or proof thereof (watermarked photos, etc.) in the possession of an overriding settlement authority will bring compensation and possibly additional levies ascribed to the purpose of justice.

Another fine example use would be as a means by which an individual could discretely parse out bits of their genetic code to a public entity such as police, courts, or a medical professional, in lieu of permitting one's entire family history of health and medical conditions to permanently enter into the sphere of public discourse and trade. Another inspiring application could enable an unhackable e-book reader or other bulwark of an economy where a market demand for a body of ideas might be a thinker's primary means of self-support. Possibly even more futuristic would be a peer-review authentication function for research lab work being offered in an international trade environment, which may benefit from avoiding the current intense emphasis on teams of expensive lawyers, who may know little of a given specialization or may deal primarily in only derivatives of some actual human concern or need.

### DETAILED DESCRIPTION OF THE PREFERRED EMBODIMENT

Much of this disclosure is provided in terms of a preferred embodiment directed at the inherent preference of capital systems toward innovation instead of efficiency. A selection of early 20th century military engineering technology—popular instruments of contemporary economic leverage—arranged below illustrates a capitalist economy practicing what it preaches.

Rather than claim that the architects of U.S. local and regional private commuter infrastructure did what they could with what was available, let's look deeper into the classic American analogy of modern self-determination: The Ford racing-car model of motor transportation development.

The aim of this model of economic progress has been two-fold. First, automotive technology was seen as useful in developing regional economies comprised of otherwise isolated resource extraction economies, with greater alacrity than rail technology. This goodwill seems to have quickly gone from Libertarian idealism to “anything goes,” circa post-World War One. Early developments then followed a natural parallel with the standard development model of common roadways: more is always better. Since financing was always involved in automotive marketing, how much a passenger's life was worth in this scheme was vetted from their net worth, as it is true that no amount of high-technology add-ons can trump the safety afforded by the more simply massive and destructive vehicle. This business model is underscored by the aggressive featurism attached to vehicles marketed as more durable. A means of forcing dollars into vigorous circulation had been discovered.

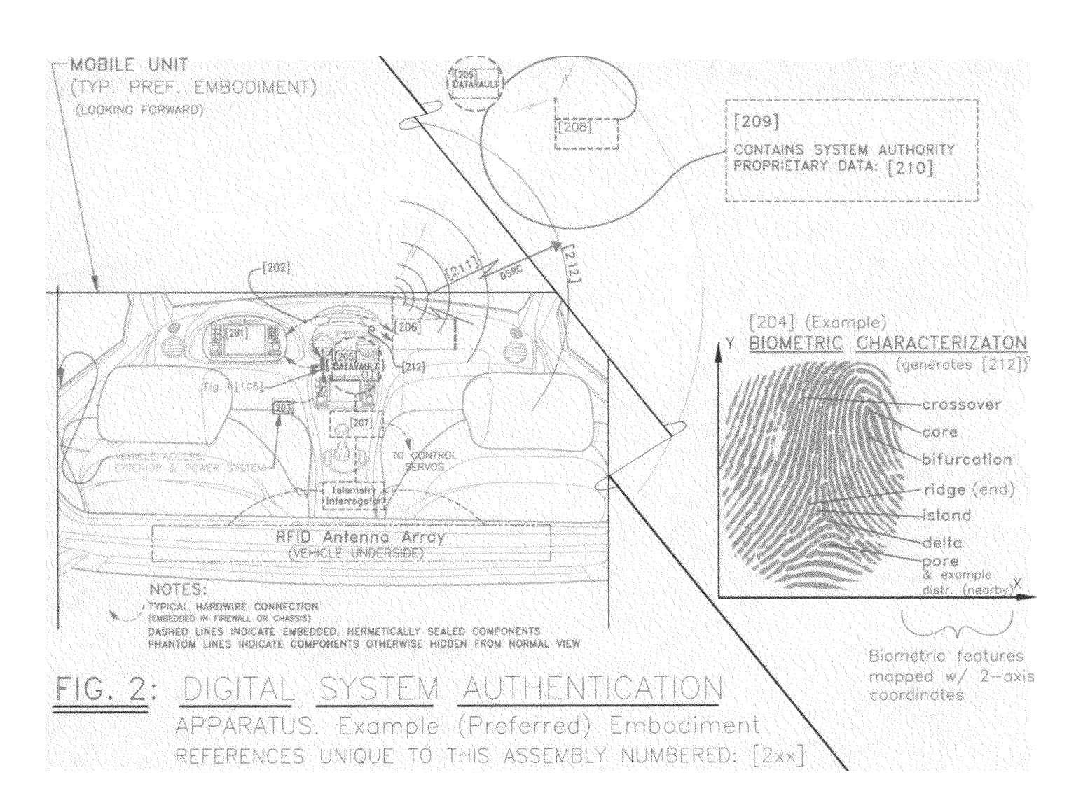

Fingerprinting technology was ubiquitous before the advent of the Ford “Model T”; a combination of this with government-rented highway vehicles, and the budding telephone infrastructure, would have provided a more efficacious prosperity and democracy engine than the licensing tricks by which access to this terrible and anonymous entertainment medium has been loosed upon humanity. This disclosure has described conversion of any fingerprint into a unique numerical value. Punch cards on grid paper, and an episcope, would have augmented rudimentary electronics in our 1930's scenario. By requiring this low-tech procedure, similar to FIG. 2 [204], in advance of every intercity travel, the motorist would pass their numbers through a cipher at a local authority and an attendant would relay it to a locality at some convenient and considerate distance downrange. These localities could provide local updates and other services and would also decipher the decrypted transmission and repeat the process, ultimately, to a final destination. By this means, high-powered vehicles could have been barred from incorporated areas, in preference of efficient vehicles, say, of a power-output related to the maximum speed of a horse. Private enterprise would play an important role in this scheme, and would have benefited from a robust build-out of telecommunications technology, and also safe, very inexpensive and reliable transportation technology, some eighty years ago.

Instead of emphasizing personal technology, for use within incorporated areas, which poses minimal burden on infrastructure, resources, and human pathologies, the authorities as mentioned above decided on a development model based on dismembering roadway executions. Instead of a financial system that manages to get its currency into the places important for creating societal peace and stability, a body politic emerged to demand monuments to the peoples' struggle toward the source of this currency: bigger cities and its myriad artificial scarcities. It is true that there are few places on earth convenient to human existence, so we have seen that robust physical communication and vigorous resource extraction can increase statistical measures of population size and longevity. The human mind innately generalizes sprawling demands for quantity, so that a superficial reliance upon larger vehicles, be they automotive, financial, or fiscal, drowns out more subtle and relevant approaches to human safety and wellness. Legislators typically ascribe a need for this abuse to their professional “requirements” for eschewing anything to do with human tool use, in favor of “cultural affects” embodying some sort of pedantic and erstwhile socializing qualities. Hubris, too, creates perceived neediness. By abdicating their national resources oversight charter, governments force vertical, or pyramidal, social solutions.

The preferred embodiment of the present invention envisions a contemporary update to the above post-WWI scenario. It assumes the availability of the aforementioned embodiments of the present invention, and also assumes fullest adoption or market penetration of the Present Invention. As alluded to in prognosticating the breakdown of Moore's Law in the Background, the Preferred Embodiment assumes that signing over the people's basic security to private enterprise nonsensically insulates government from their primary station.

The “dual nature” of identity authentication schemes mentioned in the Background section is due to free market balkanization, more than anything. Claim (15) enumerates the technology required for a basic functioning infrastructure capable of providing full penetration of the Data Safe of the present invention to a large, western-style economy. The claim implies that ubiquitous Wireless Internet service is fact or is factually in progress. The claim is called “Automated Private Commuter System.”

FIG. 2 illustrates the basic concept of a low-cost APCS. A digitizer with an approximately passcard-form-factor (7) sends biometrics from the user to the vehicular Data Safe [205] by handheld console or with port [203]. Digitizer serial number bypasses [205] and energizes vehicle navigation system [201] while authorization transmission proceeds [211], claim (16-c), by Digital Short Range Communications (DSRC [211]) so that user may select destination choice and may even enter traffic with a temporary routing contract generated by the onboard navigation system from a “gestalt” of local system-usage data downloaded from the current information held by the central authority, and then issued a blank serial number for anonymous entry toward their destination once an actual authentication has been received, according to one embodiment of (16)(e). This step may be performed at any console with a compatible scanner interface. Vehicle operator nominally authenticates first, then guides the vehicle onto the nearest transponder-prepared roadway, so that vehicle automatically proceeds toward destination according to an internal digital map of all possible locations. The system authority file server adjusts traffic accordingly to accept the new entry whether the normal security logon is used, or the method of notifying, manually entering, and finally authenticating before approaching any security of traffic bottlenecks. An authorization request is fully transmitted at the earliest point at which non-adjacent base stations receive the last of thusly-hashed data file contents. This transmission is deeply encrypted from the biometric seed and is hashed onto the authority's dedicated network, for eavesdropping protection over wireless networks. Authorization requests transmitted by non-vehicle console means (i.e., PC-based, non-APCS) must travel over commercial networks to the data collocation center with the same format of route request within the header, and encrypted dataset as body. Authentication is returned to authority server computer [208/209] over dedicated network, without encryption or biometric signature. Route plan comprised of distance and bearing sequences is returned to vehicle DSRC transceiver such as MCNU, and proceeds to user GUI for user-acceptance or rejection and also through entombed DS [205] and Logic Control Unit [207] where plan is converted to digital servo motor instructions to be used by control and propulsive motors. DSRC “base station” units are made available throughout a public-supported local or regional authority with overlapping coverage so as to insure a usable log-on service at any location. The DSRC protocol includes a zero-knowledge authentication method similar to (12), FIG. 3, and otherwise appearing in the Description of the Present Invention. Also useful for a practical, wireless, dedicated network for secure transmissions is the internal, transparent issue of PINs, varying according to automated instructions received from the authority file server [209] during the previous authenticated user session. This voucher approach obviates methods in the prior Description involving so-called “hard points” (for onboard value transactions) and also the security advantages of the packet-hashing method for non-vehicle, stationary, console transmissions, therein. This also indicates that the full-adoption scenario (this preferred embodiment) offers much greater security than the purely commercial embodiment already detailed previously as a logical extension of browser-based commerce, and is compatible with all objects of the present invention, including commerce.

As (18) accommodates for deliberately or incidentally useless interaction with the present invention, described in the final embodiments therein, the above feature of the preferred embodiment accommodates for any failures of a route plan to maintain forward progress. Emergent difficulties can be handled automatically by accelerometers and engine telemetry, in the case of sudden, unreported traction or environmental degradation; by mileage, in the case of regular maintenance requirements; or by user emergency-stop button. In any emergency exit from a given route plan, an instantaneous panoramic video capture capability allows for authoritative determination of actual causes of the breach of contract. This can be useful for law enforcement efforts, if a vehicular Data Safe is for dedicated-use and not general-purpose computing—although value transactions are unaffected by this. In the case of truly chaotic obstructions to traffic flow such as wildlife incursions, an onboard Thermal Laser System may be useful in removing them, in regions where this is a typical problem.

In generalities, then, a system specification is first proven safe, effective, and scalable, and then this specification becomes public domain. Adoption by various localities, individually, requires unguided traffic be barred and rentals required of visitors, or requiring retrofit kits and commercial licensing such as for all freight traffic. The antenna array of claim (17) is essential equipment for the APCS vehicles, as well as retrofits, being oriented perpendicular to the roadway and its defining sequence of passive transponders, so that lateral drift of a vehicle from the roadway centerline can be determined by distinguishing which antenna in the array receives the transponder response. The transponders are similar to department-store RFID tags, and simultaneously provide GPS coordinates programmed therein, thereby disclosing a vehicle's 2-D position in space. This is, essentially, the invention of the ultralight commuter vehicle. This provides real-time telemetry to the vehicle, but also to the relay stations such as Technocom Inc's “MCNU” devices, which results in an accurate representation within a file server of the overall state of traffic. The file server generates route plans according to user's needs when they authenticate themselves to use the system as in (16), and may be maintained by the same authority as the co-location center of user's Data Safes.

Telemetry, especially as obtained from passive RF transponders, provides for lightly-constructed, inexpensive roadways, and also negates any Artificial Intelligence requirement, thus making a basic such vehicle simple and cheap, and reliable. Freight traffic uses these pavements only at moderate and consistent speeds, or for turning. A typical two-lane roadway does not then accommodate two-way traffic, but instead has a commuter lane and a freight lane. This can vary daily or even hourly, according to the needs of the local economy for rush-hour uses or such. Also, users might pay extra for certain routing at certain times, and pedestrians would have an RF FOB device to allow them some number of free traffic crossings per period, after which their digitizer/console device might be needed.

In the virtual realm, security from internal breaches is fortified by a network dedicated for use solely between central Data Safes and corresponding vehicular Data Safes. Automated rotating passwords and care by users in making value transactions only when physically inaccessible by eavesdroppers, such as at home or while in motion, prevents assault by external speculators.

It is in the nature of all things left private that a possibility exists for a breach to occur, to the effect of some net loss. The design philosophy of the present invention is friendly to commercial transparency. A marketplace which routinely uses this system will keep it inviolable from all but the most elite cryptographic saboteurs. On the expanded level of use within the preferred embodiment, the additional automatic security of “moving targets,” so to speak, can narrow a list of potential culprits to a very obvious few. The digital and highly accessible nature of the preferred embodiment may use unheard of encryption levels, while remaining highly informative to users. The resulting psychology is such that neglect or complacency is understood to be abusive itself, leaving would-be attackers with little reason for any serious attempt at breaching the security system.

Transfer of ownership is accomplished by a method relating to the several WORM programmable microprocessors or data storage IC's purchased with the initial acquisition of a vehicle. All Data Safe operational programming is standardized and open-source. Instruction sets are simple and are compiled and entered at the time of commissioning, along with the biometrics-programming method. One WORM device contains instructions to obliterate the current owner biometrics upon entry of a data file into the next-highest internal serial-numbered biometric-storage device. The reliable means of broadcasting this event (1), such as EPIRB is automatically activated. Unofficial such attempts result in decommissioning and recycling of entire vehicle.

As for a bevy of other practical-minded concerns typical to APCS visions, the foremost tool is the knowledge that automotive technology is nothing more than automation; more a matter of planning than it is of capital intensification. Below are a few final words on currently prevailing expertise, from published sources, and from private interviews with industry leaders.

RFID engineers understand current RFID technology to be inadequately responsive to meet the speed demands of commuter transportation. Some RFID industry heavyweights have identified weaknesses with such views as to suggest that it is industry whitewash. Current RFID “tags” will sustain 100% read accuracy at pass-through speeds of 25 MPH, in controlled, albeit congested, industrial settings. Commercial & production environments mandate industry-wide compliance with FCC down-regulation of the RFID signal strength. This does NOT pertain to motoring upon highways, and the underside of a low-slung coupe can be isolated from RF interference better than a material-handling conveyor, thus greater power outputs are tolerable. Supercapacitor manufacturer Maxwell Industries currently offers high-performance energy storage for on-chip microelectronic uses, such as RFID transponders with unimagined pass-through speeds. The first optimization to be pursued, however, should be that of stripping the simplest of current RFID chips on the market of their large memory capacity and complex data-transmission computing overhead. Roadway sequences of GPS-programmed chips will never encounter any “data collision” which is a feature in production settings involving entire pallets of RFID-tagged goods. This alone may increase 100% read levels to 35 MPH. Also, a positive “ping” of a chip by a tag reader, even without a solid data “read,” can be used to ascertain roadway centerline-positioning, according to which of several closely-spaced antennas (19) completes the “ping.” This occurs reliably far beyond 45 MPH. These numbers do not include improvements due to signal power increases. Beyond 45 MPH, any vehicle becomes essentially ballistic, requiring more roadway-per-vehicle, so that lower-precision satellite GPS becomes useful for tracking forward-motion. There is not a definite upper speed limit to this capability, either.

It is assumed that when a common utility or service becomes mundane enough and menial enough to no longer warrant the doting of skilled private enterprises, such activities will either be displaced by the “next hot thing” or will enter into a government-sponsored infrastructure, in a sort of capitalist limbo. Private commuter transportation is seen herein as having reached that stage wherein it may become an automated system and thus usefully serve as bridge to a less consumerist, but more empowered economy. In fact, the Intelligent Transportation Systems (ITS) adjunct to the U.S. DOT has spent during the years 1994-2008 several billion tax dollars on this exact vision, also inviting double this investment through corporate and other private-sector funds. It is in the securing of human lives engaged in the discovery of a more genuinely meaningful place in the world to which this invention is dedicated, for illustrative purposes proffered herein as the preferred embodiment.

Furthermore, in the advent of said “Automated Private Commuter System”, there will be drastically less need for public verification of private citizens for public needs. The ID-cloaking feature of the present invention is seen as crucial in providing for such an automated commuter system for private enterprise, which produced the claims herein before any commerce-driven claims were ever begun. The human-rights issues inherent in personal transportation are seen to be only slightly more grave than the other constitutional issues imbued into matters of private enterprise and the related self-determination of the individual. For this reason, a governmental role is assumed to be vital in supporting some personal identification authorization infrastructure, especially in this vast country.

### SUMMARY OF THE PREFERRED EMBODIMENT

Between mundane retail applications in the manner of PayPal®, and decidedly more futuristic incorporations as might be found in a flourishing knowledge-based economy, lies the preferred embodiment to the present invention. The present invention is better-suited to human pursuits which are more relevant to the human condition, require considerable subtlety, and are inherently more powerful in their implications.

This disclosure assumes that a failure to examine Root Causes of common need is the recipe for a “tragedy of the commons.” In this sense, the institution of capitalism exists as a government externality, being simple predation if not accompanied by certain rather staid staples of human interaction, which are wisely relegated to government support. Privatizing such interests introduces nested moral perils, which is capital intensification for its own sake, and which performs the same as the militarized economics such privatization ostensibly would be replacing, yet requires arguably greater human labors to accomplish. Such hubris is how history fails upwardly, toward extreme modes and costs of living.

It is therefore an object of the present invention of reducing the role of vertical markets or political authorities in reinforcing the larger economy in times when there may be generalized lack of interest

It is an object of the present invention to provide a system for identity authentications which prove reliable for all users, with a further object being the logical extension of this as an object of the Preferred Embodiment (the P.E.) to ubiquity, and at various times, including when responsiveness to the condition of the user may be necessary.

Such a system as is aspired to in the present invention may be based upon automated biometric imaging systems, or on other random affects of a personal nature, such as digital vouchers generated from geographic location (GPS). However, the goal of any security measure is to permit the free exchange of successful value transactions among willing participants—from simple free association to all levels of business commerce. Other personal authentication methods can have clearly better convenience while retaining the prospect of equivalent levels of security in their embodiments, but therein lies the undoing of all these other methods. Any successful security protection must involve voluntary action by an interested actor. Any fully automated security method will either prove unpopular, or it will fail to protect.

It is therefore an object of the Preferred Embodiment to force the least amount of user involvement while retaining the most protection of any method. It is a closely allied matter that the overall system costs will be less than any other method. It is hoped that the preferred embodiment herein describes an overall system with inherently improved security as its popularity is increased, by whatever means.

Another object is to promote the growth of dedicated networking lines to provide partial coverage by such lines for the embodiments herein. Furthermore it is an object to promote the final execution of value transactions from an APCS vehicle, through dedicated wireless Internet service so as to deny attempts at eavesdropping.

An object which expands upon the previous mention is to provide ubiquitous packet technology networking or other popular, public such means as an adjunct to the DSRC means of the invention.

Another object related to the above is provide a means of vehicle-vehicle communications related to emergent-conditions and related telemetry.

Yet another object is to encourage the popularity of less expensive road infrastructure for non-commercial purposes, and to increase the capacity utilization of all road transportation. These benefits are intended to be obtainable with modest additions to existing infrastructure, and negation of much existing infrastructure, without any specific demolitions or replacements.

Another object is to reduce or even to remove, entirely, environmental and aesthetic degradations related to road traffic.

Another object is to reduce wasted human labors.

Another object is the diminishment of the economic authority of large population centers, and the harm inherent in such concentrations to democratic processes.

A vital object is to reduce road traffic casualties and emergent expenses to near zero.

Another object is improvement of socio-economic stability and sustainability from green economic development.

Yet another object is to de-emphasize macroeconomic reliance upon “push” production systems.

Another object is to encourage automated forms of transportation, including air transportation, and especially private air transportation which may rely on current FAA “Highway In The Sky” technology.

Although preferred embodiments herein have described biometric authentication for value-added and gatekeeper transactions in networked environments of a scope ranging from user-only or interpersonal applications, to ubiquitous nation-wide uses, the structural features specified herein are limited examples of the subject of the appended claims. Skill in the art of such means will confirm that modification to such features does not invalidate the subject of the present invention.

What is claimed is:

1. A data-matching access-circuitry apparatus, referred to herein as “datasafe” or “datavault” means of secure data storage, comprising:
a structural frame for housing small electronic devices;
a plurality of paired conductive foil sheets forming a foil-pair circuit, wherein a foil pair is separated by an insulator of minimal structural strength and of a minimal thickness in excess of the arcing distance provided by an electric potential difference across the foil sheets sufficient for positive response upon circuit closure, such as polymer sheets made conductive to low-voltage current, the foil sheets having a minimal overall resistance to strain across the foil thickness, but strong enough or otherwise fortified to resist making contact when submerged in a slightly larger chamber filled with a fluid substance;
an enclosure for electronic devices comprised of said non-conductive frame and foil pairs which contains overall: an inductive means of electric charging and a compatible means of electrical power storage to charge thereby; a near-field RF or other secure means of digital data communication including RAM memory buffer for incoming signals; a so-called WORM storage means; and microprocessor for comparing incoming signals from mathematically-characterized biometrics which are user-programmed into WORM storage means, using encryption/decryption digital computer instructions also stored therein; a computer Operating System for directing input and output signals; any other mass-storage means; a chemical or electrical means of obliterating all data within WORM storage and optionally also within any other included mass data storage; and also comprising several ambient-energy-change sensors which may initiate, in like manner as an actual user of said datasafe, the said chemical or electrical obliteration event, and a similar reliable means of broadcasting or transmitting the event to authorities of the user's choice;
a means of physically protecting and concealing a small delicate object from electromagnetic or mechanical probing or other means of detecting characteristics of said object in the manner of said foil-pairs, and also resistant to heat ablation, and of an overall size and shape which is integral with a random factor of determination, which may include electrically-reactive fibers.

2. A data-matching access-circuitry apparatus as described in claim (1), such that any prolonged loss of external power supply which does not exceed the charge-life of said energy-storage means, as well as any temperature change beyond that caused by said inductive charging means causes said microprocessor and said sensors/circuitry to close a circuit in the manner of (1).

3. A data-matching access-circuitry apparatus as described in claim (2) as having sufficient design simplicity as to permit anyone with an approximately average manual dexterity and comprehension of written or verbal commands, to assemble the aforementioned prismatic frame, its several other enclosed discrete electronic components, and finally also the means of resisting detection such as said foil-pairs affixed to their frame, in a short time and by hand or with a bare minimum of tools as needed to result in a device of the current invention, ready for concealment by same user within said means of protection, and any subsequent entombment within similar means as may be needed for immediate use.

4. A data-matching access-circuitry apparatus as described in claim (3), entombed within said means of protection and of sufficient design simplicity as to permit anyone as in (3), at the time of assembly, to digitally program the data storage means with each of the user's biometric datasets or mathematical characterization thereof and also with encryption algorithms of the user's choice or other such digital computer instructions as are needed to effect encrypted transmissions through aforementioned apparatus, and a user selection of which of these digital items will initially be used for reception and decoding of the user's self-authorization transmission.

5. A method of use for the data-matching access circuitry apparatus as described in claim (4) wherein said biometric dataset, sequestered as in previous claims herein, is matched by the user upon initial assembly, in the presence of the hosting authority, using the prescribed method and a scanner capable of the required protocol and provided to the authority for inspection, to validate the positive functioning of the system of entombed components of the user's choosing and ownership.

6. A data-matching access-circuitry apparatus as in claim (5), but of a prefabricated assembly or store-bought monolithic design of similar operation as in (1), with or without the rigorous power-checking feature of user-assembly and aforementioned protective entombment.

7. The data-matching access circuitry apparatus as described in (5), wherein the preferred means of generating said biometric comparison data is by unique device-numbered handheld optical biometric scanner, employing a solid-state image-capture device and operating by preferred means of hard-contact power supply and data transfer to a separate “console” device capable of wireless encrypted data transmissions.

8. The data-matching apparatus of claim (7), wherein said “console” electronic computing device generates biometric datasets according to the optical resolution of said scanning device by the steps: a) presenting one or more biometric identifying features, in succession or simultaneously, to an optical or other biometric scanner; b) optionally entering a user-specified PIN into a keypad integrated within scanner or console device; said dataset or a graphical coordinate representation for biometric minutia therein finally arriving at said datasafe for match comparison.

9. The data-matching access circuitry apparatus as described in claim (8), wherein said console device is integrated with said handheld scanner device as a whole.

10. The console device of (8) provided as securely affixed to the structure of a vehicle intended for autonomous automated travel, whether or not integrated with a biometric scanning device, for purposes of gaining entry to vehicle or access to its user-controls.

11. The preferred means of generating said biometric comparison data as in claim (7), and responsive enough to scan the device field-of-view repeatedly in the span of time required to present biometric identifying features to the device.

12. The data-matching access-circuitry apparatus as described in claim (3), provided with multiple static-memory storage devices, each with its own S/N, allowing for change-of-ownership while preserving ownership history and also authorized usage, wherein said S/N is not automatically obliterated with the biometrics of previous owners.

13. An additional security feature for the protection and concealment embodiment of claim (3), wherein the preferred embodiment of the present invention and unrelated but important commercial applications may benefit from any of a variety of digital, encrypted, means of communication with a centralized “data bank” of so-called data-safes, acting on the behalf of individuals who would access their own self-programmed secure data, said individual secure data vaults entombed en masse in said “colocation site,” thus making physically impossible unauthorized contact of any such datasafe without the contents being subject to user-specified security response per (1), whether a violator be of a legal capacity or of some other extralegal agency.

14. A method of use for the present invention, comprising the steps: a) a first, or inquiring, agent and a second, or supply, agent each exchanging one electronic message, including transaction details for value exchange and fulfillment routing; b) each agent processes their own biometric features through their own scanner device, as in (7); c) console device as in (8) encodes transaction details and message routing destination according to mathematical instructions based upon a so-called seed value, as provided by biometric scanner; d) console transmits encrypted message to personal match-server device; e) personal match server of first agent decodes a message labeled with the appropriate serial number and further transmits message, with settlement details from encoded message transferred to said label, to payment institution or to other security authority as specified, while second agent message is routed in a similar manner, but originating from second agent match server; f) chosen authority transfers funds to that of second agent or receipt of authenticated message is otherwise thereby acknowledged; g) transaction is complete upon satisfactory receipt of object of interest to first agent.

15. The method of use as in (14), wherein subsequent parties to the execution of the authenticated transmissions of the present invention are aided in establishing the mutuality of said message copies from first and second agents, by the use of a so-called synchronization server placed within the network depicted in FIG. 3, before the personal match server of the present invention, or by computer instructions within said console devices of the first and second agents, when invoked within (d) of (14), thereby adding a time stamp or other means of guaranteeing mutuality to said label attributable to each transacting party as in (e) of (14).

16. The method of use as in (14), wherein a second copy of message as in (e) is also transmitted to a settlement authority of last resort, being held therein agnostically, with only said serial numbers available to anyone knowledgeable of the pertinent means of synchronization as in (15).

17. The data-matching access circuitry apparatus described in claim (3), as applied to a system of the preferred embodiment of the present invention, comprising: (a) a prepared hard surface roadway upon which are affixed radio-frequency memory circuits programmed with geographic positioning identification coordinates; (b) a digital computer “file server,” maintained by or connected by dedicated network of the “hosting authority” for a public or commercial so-called “farm” of said datasafes of the present invention as in (13), and capable of supporting a large number of simultaneous networked connections; (c) a network of wireless, digital relay stations capable of providing remote data from field users in numbers adequate for use of aforementioned “file server”, and of adequate transaction-processing power for optimal capacity utilization of the areas of roadways to which each relay station is assigned within the hosting authority or other ownership boundaries; (d) a mobile unit for commuter transport or lightweight freight use, consisting primarily of: a Datasafe as in (1) entombed as integral within a vital structural member of said mobile unit; a means of receiving said biometric comparison data generated by scanner device of (7); an on-board digital relay station of the type in (c), for receiving current travel conditions from said server for user route-planning purposes; a so-called “Driver Assistance” user navigation interface device; also a logic control programming compiler for generating device-logic sequences from authorized route plans originating at aforementioned hosting server, to be sent to vehicle servo controllers; a logic control unit, entombed similarly as the data-safe mentioned above, including logic-control microprocessor for converting device-logic instruction sequences into electrical power current for energizing vehicle control servos, which themselves mechanically operate steering and power-drive components of automated-guided vehicle (AGV), so as to cause said vehicle to follow roadway-affixed positioning transponders in a manner consistent with aforementioned authorized route plan.

18. A method of use for the present invention within the automated personal transportation system of (17), comprising the steps: a) user gains access to operational systems of AGV (17) per (10), wherein said Data Safe is entombed within AGV superstructure; b) user-selects destination requirements with said “Driver Assistance” user navigation interface of (17); c) on-board Data Safe transmits user data per (b) by wireless, digital relay stations to user Data Safe as in (13) and thence to said “file server” for gaining electronic permissions or travel directions; d) user manually navigates AGV to a roadway surface prepared with RF transponders as in (17); e) AGV assumes control of mission to a specified destination or until interrupted by user or by automated means of so-called hosting-authority of (17).

19. A necessary counterpart to the mobile unit of (17)(d), being an apparatus of RF antennas arranged in a linear array for sequentially energizing a series of transponders arranged in distinct linear patterns of consistent “intervals” between said transponders upon a surface to be traversed, whether said energy is delivered wholly by said aligned antennas or is shared by some preceding array (as for greater forward range), or by some external power source wired directly to said transponders, said sequence defining an otherwise arbitrary “forward motion” for an AGV of (17).

20. A protocol enhancement to the method of (16) in which the character-based information of a blinded transmission as described above contains a provision for entry of a user-specified synchronization marking.
